(19) United States
(12) Patent Application Publication
(10) Pub. No.: US 2025/0223519 A1
(43) Pub. Date: Jul. 10, 2025

(54) TWO-IN-ONE SOLID DETERGENT COMPOSITION AND PREPARATION METHOD THEREOF

(71) Applicant: Guangzhou Joyson Cleaning Products Co., Ltd., Guangzhou (CN)

(72) Inventors: Fenglei LI, Guangzhou (CN); Jianfeng SUN, Guangzhou (CN); Min SUN, Guangzhou (CN); Na LAN, Guangzhou (CN); Yumei HUANG, Guangzhou (CN)

(21) Appl. No.: 18/589,522

(22) Filed: Feb. 28, 2024

Related U.S. Application Data
(63) Continuation of application No. PCT/CN2024/070987, filed on Jan. 6, 2024.

(51) Int. Cl. C11D 3/00; C11D 1/29; C11D 1/722; C11D 1/831; C11D 3/12; C11D 3/22; C11D 3/37

(52) U.S. Cl. CPC C11D 3/001; C11D 1/29; C11D 1/722; C11D 1/831; C11D 3/12; C11D 3/1246; C11D 3/222; C11D 3/3738; C11D 3/3742; C11D 2111/12

(57) ABSTRACT

A two-in-one solid detergent composition includes the following raw material components based on 100% weight: 10% to 30% of (a) a forming agent, 10% to 50% of (b) a surfactant, 5% to 20% of (c) a softener, 10% to 30% of (d) a forming aid, and optionally 0.1% to 1% of (e) a softening conditioner, 0.1% to 1% of (f) a forming stabilizer, 1% to 10% of (g) a water softener, 1% to 10% of (h) a stain solubilizer or 0.1% to 5% of (i) a flavoring agent, and balance of deionized water.

### CROSS-REFERENCE TO RELATED APPLICATION

This application is a continuation of international PCT application serial no. PCT/CN2024/070987, filed on Jan. 6, 2024. The entirety of PCT application serial no. PCT/CN2024/070987 is hereby incorporated by reference herein and made a part of this specification.

### TECHNICAL FIELD

The present application relates to the technical field of detergent materials, and in particular to a two-in-one solid detergent composition and a preparation method thereof.

### BACKGROUND ART

Conventional detergents used for cleaning clothes such as fabrics are generally in a liquid state, which requires a large amount of packaging materials due to its high-water content, large volume, and has high transportation cost and a risk of leakage during storage and use. In view of this case, there are two significant methods for improving. In one method, a liquid detergent is concentrated and coated to be prepared to be granular, but coating film with high cost is needed and the preparation method is complicated. In the other method, the liquid detergent is directly prepared into a solid detergent with a regular or irregular shape, such as a sheet, granule, rod, tube shape and the like, and when the solid detergent is put into a washing apparatus, such as a washing machine, the solid detergent rapidly decomposes and disperses when it encounters water, and dissolves in the water, so as to achieve a washing effect.

Existing preparation methods of the solid detergent have the following challenges: (1) each detergent ingredient in a liquid state is compounded to form a stable solid state, and it is required that the softening or raw material ingredient precipitation does not occur at least at 60° C., and the performance is stable; (2) the water absorption capacity of the solid detergent is poor, but it may rapidly be decomposed and dispersed, dissolved in water, and quickly exert a washing effect; (3) it may exert at least the same washing effect as liquid detergent does, and there is no residue after rinsing; (4) when the cationic softener is added together to the solid detergent, precipitation of the cationic softener and the anionic surfactant shall be avoided due to the mutual adsorption of positive and negative charges with the anionic surfactant in the detergent, thereby affecting the performance thereof. Related art Chinese invention application patent CN116194562A discloses a detergent sheet. In order to avoid the adsorption and precipitation of a cationic softener and an anionic surfactant added in the detergent sheet, thereby affecting the performance thereof, the softener is coated with polyethylene glycol/polypropylene glycol first, then loaded on a carrier such as bentonite, and prepared into solid particles by a drying method such as spray drying, and then the solid particles together with the other ingredients of the detergent are prepared into the detergent sheet. The preparation steps of the detergent sheet are added in this method, and an additional drying apparatus is required, such as a spray drying apparatus, which extends the process period and increases the cost.

Therefore, it is necessary to further study the raw material selection and preparation method of a washing and softening two-in-one detergent sheet, and prepare a detergent sheet with a good effect and an easy preparation method.

### SUMMARY

In order to solve the above technical problem, the present application provides a two-in-one solid detergent composition and a preparation method thereof.

The present application adopts the following technical solutions:
a two-in-one solid detergent composition including the following raw material components based on 100% weight: 10% to 30% of (a) a forming agent, 10% to 50% of (b) a surfactant, 5% to 20% of (c) a softener, 10% to 30% of (d) a forming aid, and optionally 0.1% to 1% of (e) a softening conditioner, 0.1% to 1% of (f) a forming stabilizer, 1% to 10% of (g) a water softener, 1% to 10% of (h) a stain solubilizer or 0.1% to 5% of (i) a flavoring agent, and balance of deionized water;
the surfactant includes an anionic surfactant and a non-ionic surfactant;
the anionic surfactant has a structure R¹(EO)ₙR²M, where n=1-15, R¹ is C₄-C₂₀ hydrocarbyl or C₄-C₂₀ substituted hydrocarbyl, R² is one or more selected from the group consisting of sulfate ions, sulfonate ions, phosphate ions and carboxylate ions, M is alkali metal ions or ammonium ions, and EO represents —CH₂CH₂O—.

Preferably, a weight proportion of the anionic surfactant to the non-ionic surfactant in the surfactant is from 1:9 to 9:1.

Preferably, the surfactant further includes a zwitterionic surfactant, and a weight proportion of the zwitterionic surfactant in the surfactant is 10% to 40%.

Preferably, the forming agent is one or more selected from the group consisting of polyvinyl alcohol, polyvinyl alcohol crosslinked polymer, polyvinyl pyrrolidone and vinyl acetate-vinyl alcohol copolymer.

Preferably, the softener is one or more selected from the group consisting of an amino silicone oil, an amino silicone oil emulsion, an amino silicone oil microemulsion and a cationic polysiloxane and an emulsion thereof.

Preferably, the forming aid is one or more selected from the group consisting of anhydrous sodium sulphate, starch, kaolin, attapulgite, bentonite and silica.

Preferably, the softening conditioner is cationic cellulose.

Preferably, the forming stabilizer is one or more selected from the group consisting of hydroxyethyl cellulose, hydroxypropylmethyl cellulose, gelatin, carrageenan and polyanionic cellulose.

Preferably, the stain solubilizer is polyols having a molecular weight of not more than 150.

A preparation method of a two-in-one solid detergent composition according to any one of the above technical solutions, including the following steps:
adding the deionized water into a container, adding and dissolving the forming agent, adding and dissolving the surfactant while stirring evenly, adding and dissolving remaining components of the raw materials successively, while stirring evenly, to obtain a detergent slurry, drying and molding the detergent slurry, and demolding and shaping to obtain the two-in-one solid detergent composition.

In summary, the present application has the following beneficial effects:
1. The anionic surfactant used in the two-in-one solid detergent composition of the present application contains a polyoxyethylene ether segment, and it is found that when this anionic surfactant is mixed with the cationic softener selected in the present application, the precipitation, which would affecting the performance of the softener, would not occur due to charge adsorption; therefore, the softener needs not to be coated on a carrier in advance, and the preparation method is simpler.
2. The two-in-one solid detergent composition of the present application has good washing effect, the washed fabric has good anti-static effect and good flexibility, and good washing effect and good anti-static effect may be maintained when being mixed with other detergents and used together.
3. The two-in-one solid detergent composition of the present application has good storage performance stability, a softening temperature exceeding 60° C., and meets the requirements for dry resistance and wet resistance.

### DETAILED DESCRIPTION

In order that the objects, aspects, and advantages of the present invention will become more apparent, a detailed description of the present invention will be provided below.

Throughout the description, terms used herein should be understood as generally used in the art, unless otherwise indicated. Accordingly, unless otherwise defined, all technical and scientific terms used herein have the same meaning as commonly understood by a person skilled in the art to which the present invention belongs. In case of conflict, the present description will control.

On one hand, the present application provides a two-in-one solid detergent composition including the following raw material components based on 100% weight: 10% to 30% of (a) a forming agent, 10% to 50% of (b) a surfactant, 5% to 20% of (c) a softener, 10% to 30% of (d) a forming aid, and optionally 0.1% to 1% of (e) a softening conditioner, 0.1% to 1% of (f) a forming stabilizer, 1% to 10% of (g) a water softener, 1% to 10% of (h) a stain solubilizer or 0.1% to 5% of (i) a flavoring agent, and balance of deionized water.

### (a) Forming Agent

The forming agent plays a forming role in the solid detergent composition and has good water solubility, and may be one or more selected from the group consisting of polyvinyl alcohol, polyvinyl alcohol crosslinked polymer, polyvinyl pyrrolidone and vinyl acetate-vinyl alcohol copolymer. Taking the polyvinyl alcohol PVA as an example, the alcoholysis degree of the PVA of the present application is 86%-89%, and the PVA may has a low polymerization degree (a number-average molecular weight of 20,000-100,000), a medium polymerization degree (a number-average molecular weight of 120,000-150,000), a high polymerization degree (a number-average molecular weight of 170,000-220,000) or an ultra-high polymerization degree (a number-average molecular weight of 250,000-300,000). As an example, the PVA may be BP-05, BP-17, PVA17-88, and the like. As an example, the polyvinylpyrrolidone PVP may be PVP K30, PVP K60, PVP K90 and the like.

In the present application, further, the weight proportion of the forming agent in the detergent composition may be 10% to 25%, and by way of example, may be any one of 10%, 12%, 14%, 15%, 16%, 18%, 20%, 22%, 24%, 25% and the like.

### (b) Surfactant

A surfactant is a major ingredient that exerts the washing effect of a detergent. In the present application, the surfactant includes an anionic surfactant and a non-ionic surfactant, and a weight proportion of the anionic surfactant to the non-ionic surfactant may be 1:9-9:1. In particular, the anionic surfactant has a structure R¹ (EO)ₙR²M, where n=1-15, R¹ is C₄-C₂₀ hydrocarbyl or C₄-C₂₀ substituted hydrocarbyl, R² is one or more selected from the group consisting of sulfate ions, sulfonate ions, phosphate ions and carboxylate ions, M is alkali metal ions or ammonium ions, and EO represents —CH₂CH₂O—. By way of example, the anionic surfactant may be C₁₂H₂₅(EO)₃OSO₃Na, C₈H₁₇(EO)₂OSO₃Na, C₁₂H₂₅(EO)₃OSO₃NH₄, C₁₅H₃₁(EO)₄OSO₃Na, C₁₂H₂₅O(EO)₄CH₂CH₂SO₃Na, C₁₅H₃₁O(EO)₅CH₂CH₂SO₃Na, C₁₈H₃₇O(EO)₅CH₂CH₂SO₃Na, C₁₂₋₁₄H₂₅₋₂₉O(EO)₁₀CH₂COONa, C₁₂₋₁₄H₂₅₋₂₉O(EO)₈CH₂COONa and the like. The non-ionic surfactant is not particularly limited, and by way of example, may be alkyl glucoside, maltoside, alcohol ether glycoside, fatty alcohol polyoxyethylene ether AEO-3, AEO-7, AEO-9, AEO-12, alkanolamide, isomeric decanol polyoxyethylene ether, isomeric tridecanol polyoxyethylene ether, secondary alcohol polyoxyethylene ether, EO-PO block polyoxyethylene ether, and fatty acid oil ester ethoxylate.

The anionic surfactant and the non-ionic surfactant may be compounded to achieve good cleaning and deterging effect. In the present application, since the washing and softening two-in-one solid detergent composition of the present application contains a softener, the softener is generally cationic, and it is easy to have anion and cation adsorption with an anionic surfactant, to affect the water solubility and cause precipitation, which affects the product stability, washing and softening effects of the detergent. The applicant has found that the use of an anionic surfactant having an ethoxy structure, when mixed with a softener, would not result in precipitation, and does not affect the cleaning and softening effect of the detergent composition.

In the present application, the weight of the anionic surfactant and the non-ionic surfactant and the weight proportion thereof in the surfactant are not particularly limited, but generally above 60% is preferred. In addition, the weight proportion of the anionic surfactant to the non-ionic surfactant in the surfactant may further be 6:1 to 1:3, and by way of example, the weight proportion may be any one of 6:1, 5:1, 4:1, 3:1, 2:1, 1:1, 1:2, 1:3 and the like.

In the present application, the surfactant may further include a zwitterionic surfactant. The zwitterionic surfactant has a relatively low toxicity and irritation, and has good wettability and foaming property, and also has a certain bactericidal and mold inhibition property, and may produce additivity when it is compounded with an anionic surfactant and/or a non-ionic surfactant. The zwitterionic surfactant may be selected from betaine type, amine oxide type or imidazoline type, or a combination of two or more thereof, and by way of example, may be cocoamidopropyl betaine, lauroylamidopropyl betaine, cocoamidopropyl hydroxysultaine, cocoamidopropyl amine oxide, lauroylamidopropyl amine oxide, disodium cocoamphodiacetate, disodium lauroylamphodiacetate and the like. The weight proportion of the zwitterionic surfactant in the surfactant is 10% to 40%, and by way of example, the weight proportion may be any one of 10%, 12%, 15%, 18%, 20%, 22%, 25%, 27%, 30%, 32%, 35%, 37%, 40% and the like.

In the present application, further, the weight proportion of the surfactant in the detergent may be 20% to 40%, and by way of example, may be any one of 20%, 22%, 24%, 25%, 26%, 28%, 30%, 32%, 33%, 35%, 37%, 38%, 40% by weight and the like.

### (c) Softener

The addition of a softener to the detergent composition of the present application may improve the softness, smoothness and anti-static properties of the fabric and make it more comfortable to wear. In particular, the softener may be one or more selected from the group consisting of an amino silicone oil, an amino silicone oil emulsion, an amino silicone oil microemulsion and a cationic polysiloxane and an emulsion thereof. The amino silicone oil emulsion and the amino silicone oil microemulsion are generally acidic and the amino groups are positively charged, which may improve the stability of the emulsion or microemulsion. Cationic polysiloxanes generally refer to silicones of the quaternary ammonium type, i.e. containing quaternary ammonium groups in the side chain structure of the silicone molecule. The softener may also be compounded by two or more different softeners, especially one of which is cationic (such as amino silicone oil emulsion, amino silicone oil microemulsion, quaternary ammonium salt type silicone emulsion and the like), so as to exert synergistic effects and improve the effects. By way of example, the softener may be a combination of polyether-modified polysiloxane and amino silicone oil emulsion in a weight ratio of 1:2-10, combination of polyether-modified polysiloxane and amino silicone oil microemulsion in a weight ratio of 1:2-10, combination of polyether-modified polysiloxane and quaternary ammonium salt type silicone emulsion in a weight ratio of 1:2-10, and combination of amino silicone oil emulsion and quaternary ammonium salt type silicone emulsion in a weight ratio of 5:1-1:5 and the like.

In the present application, further, the weight proportion of the softener in the detergent may be 8% to 17%, and by way of example, may be any one of 8%, 9%, 10%, 11%, 12%, 13%, 14%, 15%, 16%, 17% and the like.

### (d) Forming Aid

In the present application, the stability of the solid detergent composition may be further improved by adding a forming aid, in particular, the properties of hygroscopicity and drying resistance are satisfactory, the softening temperature is higher, and the forming aid may be one or more selected from the group consisting of anhydrous sodium sulfate, starch, kaolin, attapulgite, bentonite and silica. The average particle diameter of the forming aid is not particularly limited and may be from 1 μm to 1 mm.

In the present application, further, the weight proportion of the forming aid in the detergent may be 10% to 23%, and by way of example, may be any one of 10%, 11%, 12%, 13%, 14%, 15%, 16%, 17%, 18%, 19%, 20%, 21%, 22%, 23% and the like.

### (e) Softening Conditioner

The softening conditioner may further enhance the softening conditioning effect. In the present application, the softening conditioner may be cationic cellulose, and by way of example, may be one or more selected from the group consisting of polyquaternium-6, polyquaternium-7, polyquaternium-10, polyquaternium-39 and polyquaternium-67. Specifically, the weight proportion of the softening conditioner in the detergent may be any one of 0.1%, 0.2%, 0.3%, 0.4%, 0.5%, 0.6%, 0.7%, 0.8%, 0.9%, 1% and the like.

### (f) Forming Stabilizer

The forming stabilizer may be compounded with a forming agent, such that the forming effect and heat resistance may be further improved, and the softening temperature of the solid detergent composition may be higher. The forming stabilizer may be one or more selected from the group consisting of hydroxyethyl cellulose, hydroxypropyl methylcellulose, gelatin, carrageenan and polyanionic cellulose. Specifically, the weight proportion of the forming stabilizer in the detergent may be any one of 0.1%, 0.2%, 0.3%, 0.4%, 0.5%, 0.6%, 0.7%, 0.8%, 0.9%, 1% and the like.

### (g) Water Softener

Water softener is mainly used to combine or remove Mg²⁺, Ca²⁺, Al³⁺ and other metal ions in water, reduce the hardness of water and avoid the interaction of these metal ions with non-ionic surfactants to affect the cleaning and deterging effect. By way of example, the water softener is typically a metal ion complexant and may be one or more selected from the group consisting of tetrasodium carboxymethyl glutamate, disodium edetate, sodium gluconate, trisodium carboxymethyl alaninate, sodium hexametaphosphate and sodium citrate. Specifically, the weight proportion of the water softener in the detergent may be any one of 1%, 2%, 3%, 4%, 5%, 6%, 7%, 8%, 9%, 10% and the like.

### (h) Stain Solubilizer

The stain solubilizer may enhance the solubilization of oil stains, enhance the detergency and deterging effect. In the present application, the stain solubilizer is polyhydric alcohols having a molecular weight of not more than 150, and by way of example, may be one or more selected from the group consisting of glycerol, 1,3-propanediol, dipropylene glycol, diethylene glycol, 1,4-butanediol, pentanediol and isohexanediol. Specifically, the weight proportion of the stain solubilizer in the detergent may be any one of 1%, 2%, 3%, 4%, 5%, 6%, 7%, 8%, 9%, 10% and the like.

### (i) Flavoring Agent

Flavoring agents give a pleasant fragrance to the fabric, either by direct application of the essence and flavor or by providing the essence and flavor in the form of microcapsules in which the essence and flavor are encapsulated. Further, the weight proportion of the flavoring agent in the detergent may be 0.1% to 2%, and by way of example, may be any one of 0.1%, 0.3%, 0.5%, 0.7%, 0.8%, 1%, 1.2%, 1.2%, 1.3%, 1.5%, 1.6%, 1.8%, 2% and the like.

On the other hand, the present application provides a preparation method for the two-in-one solid detergent composition according to any one of the above technical solutions,
adding the deionized water into a container, adding and dissolving the forming agent, adding and dissolving the surfactant while stirring evenly, adding and dissolving remaining components of the raw materials successively, while stirring evenly, to obtain a detergent slurry, drying and molding the detergent slurry, and demolding and shaping to obtain the two-in-one solid detergent composition

In the preparation method for the above two-in-one solid detergent composition, the forming stabilizer and the softening conditioner may be pre-dissolved with a part of deionized water and formulated into a solution, respectively, and then added into the container for stirring and dissolution.

The technical solutions of the present application will be described in detail with reference to examples and comparative examples hereinafter.

### Example 1

The solid detergent consisted of, based on 100% weight, 22% of BP-05, 24% of AES surfactant (commercially available from Zanyu Technology Group Co., Ltd.), 6% of AEO-9, 12% of amino silicone oil emulsion (commercially available from Lvlian (Jining) Chemical Technology Co., Ltd.), 18% of kaolin with an average particle size of 100 μm, and balance of deionized water.

The deionized water was added into a container, BP-05 was added, the temperature was raised to 90° C., the solution was stirred and dissolved, and the temperature was lowered to room temperature, AES surfactant and AEO-9 were added, stirred and dissolved evenly, then kaolin was added, stirred and dispersed evenly, then an amino silicone oil emulsion was added, stirred and dissolved evenly to obtain a detergent slurry, the obtained detergent slurry was dried via a continuous infrared drying apparatus, and molded, demolded and sliced to obtain a detergent sheet.

### Example 2

Example 2 differs from Example 1 in that, 12% of amino silicone oil emulsion was replaced with a combination of 3% of polyether-modified polysiloxane (commercially available from Ji'nan Shanhai Chemical Technology Co., Ltd.) and 9% of amino silicone oil emulsion. The remaining steps were unchanged.

### Example 3

Example 3 differs from Example 1 in that, the solid detergent composition also

contained 0.5% of hydroxyethyl cellulose, and the amount of deionized water was correspondingly reduced by 0.5%. The remaining steps were unchanged.

### Comparative Example 1

Comparative Example 1 differs from Example 1 in that, the AES surfactant was replaced with an equal weight percentage of sodium lauryl sulfate. The remaining steps were unchanged.

### Comparative Example 2

Comparative Example 2 differs from Example 1 in that, without the addition of kaolin, the amount of deionized water was increased by 18%. The remaining steps were unchanged. In slicing, the hardness of the detergent composition was found to be large, the detergent composition was easy to break during slicing.

### Comparative Example 3

The raw material components of Example 1 were used. According to the related art CN116194562A, an amino silicone oil is coated with a polyethylene glycol/polypropylene glycol copolymer first and then loaded on kaolin.

Polyethylene glycol/polypropylene glycol (average molecular weight 2000, 70% of EO and 30% of PO) in an amount equal to the weight of the amino silicone oil microemulsion was placed into a container, heated to melt, the amino silicone oil emulsion and 60% kaolin were added, stirred and mixed evenly, and the molded softener particles were spray dried.

According to the preparation method of Example 1, the remaining 40% kaolin was added simultaneously with the softener particles described above.

The performance test results of Examples 1-3 and Comparative Examples 1-3 are shown in Table 1 below.

Stability of the detergent slurry: the detergent slurry was left at room temperature for 24 hours and observed for any precipitation.

Softening temperature of the detergent sheet: the Vicat softening point test was carried out with a load of 1 kg.

Hygroscopicity of the detergent sheet: 100±1 g of the detergent sheet was placed in an environment of 37° C. and 75±1% humidity for 24 hours, and the weight of the detergent sheet before and after the placing was weighed, to calculate the weight gain rate. Weight gain rate=(weight after the placing−weight before the placing)/weight before the placing×100%. The weight gain rate is required to be 5%-10%. When the weight gain rate is too low, the detergent sheet has poor water absorption, and disperses and dissolves slowly in use; and when the weight gain rate is too high, the water absorption of the detergent sheet is too good, and it is easy to absorb water vapor gradually during the storage process, resulting in the problems of softening and adhesion.

The drying resistance of the detergent sheet: 100±1g of the detergent sheet was placed in an oven at 55±1° C. for 24 hours, the weight before and after baking was weighed, and the weight loss rate was calculated. Weight loss rate=(weight before baking−weight after baking)/weight before baking×100%. The weight loss rate is required to be ≤15%.

TABLE 1

| | | | Weight | Weight |
|---|---|---|---|---|
| | | Softening | gain | loss |
| | Slurry stability | temperature/° C. | rate/% | rate/% |
| Example 1 | Stable, without | 62 | 6.7 | 2.2 |
| | precipitation | | | |
| Example 2 | Stable, without | 61 | 7.1 | 2.4 |
| | precipitation | | | |
| Example 3 | Stable, without | 65 | 7.9 | 1.9 |
| | precipitation | | | |
| Comparative | Precipitation occurs | 62 | 6.9 | 2.1 |
| Example 1 | within 1 hour | | | |
| Comparative | Stable, without | 57 | 3.8 | 3.0 |
| Example 2 | precipitation | | | |
| Comparative | Stable, without | 61 | 4.1 | 2.6 |
| Example 3 | precipitation | | | |

It can be seen from the above-mentioned data results in Table 1 that, in the preparation process of the two-in-one detergent sheet of the present application, the slurry stability is good, the softening temperature is high, and the weight gain rate and weight loss rate both meet the requirements. In Comparative Example 2, when no forming aid was added, the softening temperature decreased obviously and the weight gain rate was also low, which did not meet the requirements. In Comparative Example 3, the preparation is carried out according to the existing method, the weight gain rate was also unsatisfactory.

### Example 4

The solid detergent consisted of, based on 100% weight, 10% of BP-17, 20% of AES surfactant (commercially available from Shandong Runyue Chemical Co., Ltd.), 5% of C₁₂₋₁₆ alkyl glycoside, 10% of cocoyl aminopropyl betaine, 2% of polyether-modified polysiloxane of Example 2, 10% of amino silicone oil microemulsion (TS-8378, commercially available from Guangdong Tiansheng Environmental Protection New Material Technology Co., Ltd.), 16% of bentonite with an average particle size of 150 μm, 5% of amylose, 0.5% of polyquaternium-6, 0.6% of hydroxypropyl methylcellulose, 2% of EDTA-disodium, 3% of propylene glycol, and balance of deionized water.

Deionized water was added into a container, BP-17 was added, the temperature was raised to 92° C., the solution was stirred and dissolved, and the temperature was lowered to room temperature, AES surfactant, C₁₂₋₁₆ alkyl glycoside and cocoylamine propyl betaine were added, stirred and dissolved evenly, then hydroxypropyl methyl cellulose, bentonite and amylose were added, stirred and dispersed evenly, then polyether-modified polysiloxane, amino silicone oil microemulsion, polyquaternium-6, EDTA-disodium and propylene glycol were added, stirred and dissolved evenly to obtain a detergent slurry, and the obtained detergent slurry was dried via a continuous infrared drying apparatus, and molded, demoulded and sliced to obtain a detergent sheet.

### Example 5

Example 5 differs from Example 4 in that: the amount of the AES surfactant was adjusted from 20% to 15% and the amount of the C12-16 alkyl glycoside was adjusted from 5% to 10%. The remaining steps were unchanged.

### Example 6

Example 6 differs from Example 4 in that: the amount of the AES surfactant was adjusted from 20% to 10% and the amount of the C₁₂₋₁₆ alkyl glycoside was adjusted from 5% to 15%. The remaining steps were unchanged.

### Example 7

Example 7 differs from Example 4 in that: the polyether-modified polysiloxane was replaced by an equal weight of a silicone oil of the quaternary ammonium type (HANSA SQ2030D). The remaining steps were unchanged.

### Example 8

Example 8 differs from Example 4 in that: the amount of the bentonite was adjusted from 16% to 8% and the amount of deionized water was increased accordingly. The remaining steps were unchanged.

### Example 9

Example 9 differs from Example 4 in that: the amount of the amylose was adjusted from 5% to 2% and the amount of deionized water was increased accordingly. The remaining steps were unchanged.

### Comparative Example 4

Comparative Example 4 differs from Example 4 in that: the AES surfactant was replaced with an equal weight of sodium lauryl sulfate. The remaining steps were unchanged.

### Comparative Example 5

Comparative Example 5 differs from Example 4 in that: without the addition of bentonite and amylose, the amount of deionized water was increased accordingly. The remaining steps were unchanged. In slicing, the hardness of the detergent composition was found to be large, the detergent composition was easy to break during slicing.

### Comparative Example 6

Comparative Example 6 differs from Example 4 in that: the amount of the bentonite was adjusted from 16% to 5%, the amount of the amylose was adjusted from 5% to 2%, and the amount of deionized water was increased accordingly. The remaining steps were unchanged.

### Comparative Example 7

Comparative Example 7 differs from Example 4 in that: according to the preparation method of Comparative Example 3, the amino silicone oil microemulsion was coated with polyethylene glycol/polypropylene glycol copolymer and loaded on 60% bentonite by weight. The remaining steps were unchanged.

### Comparative Example 8

Comparative Example 8 differs from Example 4 in that: according to the preparation method of Comparative Example 3, the amino silicone oil microemulsion was coated with polyethylene glycol/polypropylene glycol copolymer and loaded on 30% bentonite by weight. The remaining steps were unchanged.

Detergent slurry stability and softening temperature were tested as described above. The results are as shown in Table 2 below.

TABLE 2

| | | Softening |
|---|---|---|
| | Slurry stability | temperature/° C. |
| Example 4 | Stable, without | 63 |
| | precipitation | |
| Example 5 | Stable, without | 61 |
| | precipitation | |
| Example 6 | Stable, without | 60 |
| | precipitation | |
| Example 7 | Stable, without | 65 |
| | precipitation | |
| Example 8 | Stable, without | 61 |
| | precipitation | |
| Example 9 | Stable, without | 62 |
| | precipitation | |
| Comparative | Precipitation occurs | 63 |
| Example 4 | within 1 hour | |
| Comparative | Stable, without | 55 |
| Example 5 | precipitation | |
| Comparative | Stable, without | 57 |
| Example 6 | precipitation | |
| Comparative | Stable, without | 61 |
| Example 7 | precipitation | |
| Comparative | Stable, without | 62 |
| Example 8 | precipitation | |

It can be seen from the data in Table 2 that, with the use of sodium dodecyl sulfate as the anionic surfactant in the presence of other materials such as zwitterionic surfactants, the slurry still generated precipitates. If the amount of the forming aid is insufficient, the softening temperature of the detergent sheet is affected.

Detergency test: the test was performed according to the method specified in GB/T 13174-2021 “Determination of Detergency and Cycle of Washing Property for Laundry Detergents” in combination with the requirements of QB/T 1224-2012 “Liquid Detergent for Fabric”.

The national standard carbon black stain cloth (JB-01 stain cloth), national standard protein stain cloth (JB-02 stain cloth) and national standard sebum stain cloth (JB-03 stain cloth) were cut into pieces of 6 cm×6 cm, and devided into 22 groups with similar average blackness according to categories, and each group of test pieces was used for the performance test of the same sample. National standard stain cloth and standard formulated laundry detergent were commercially available from the China Research Institute of Daily Chemical Industry.

The whiteness values before and after washing were tested one by one with a whiteness meter at 457 nm. Detergents were used at a concentration of 0.2% by weight. The whiteness value before washing was measured by taking two points respectively on the front and back sides of the test piece (the two points on each side should be symmetrical with the center), and the average value of four measurements was taken as the whiteness value before washing F1 of the test piece; the whiteness value after washing was measured by taking two points respectively on the front and back sides of the test piece (the two points on each side shall be symmetrical with the center), and the average value of four measurements was taken as the whiteness value after washing F2 of the test piece.

The whiteness value difference before and after washing (F2−F1) of each test piece was calculated in a one-to-one correspondence, and the detergency was respectively calculated for each group of test pieces. A deterging value R and a deterging ratio P of the detergent on various types of stain cloths were respectively calculated according to different types of stain cloth test pieces, and the method was as follows.

Calculation of stain cloth deterging value: the deterging value of a certain stain cloth Ri=Σ(F2i−F1i)/n;
where
i refers to i^{th} stain cloth test piece;
F1i refers to the spectral reflectance before washing the i^{th} kind of stain cloth test piece, %;
F2i refers to the spectral reflectance after washing the ith kind of stain cloth test piece, %;
n refers to the effective number of each group of stain cloth test pieces.

A result is obtained by rounding off with one number retained after a decimal point.

Calculation of the deterging ratio of the stain cloth: the deterging ratio relative to the standard laundry detergent at the i^{th} kind of the stain cloth, Pi=R3i/R0i;
in the formula: R0i refers to a deterging value of the standard laundry detergent, %; R3i refers to the deterging value of a sample to be tested, %.

A result is obtained by rounding off with one number retained after a decimal point.

Determination of detergency of a detergent:
(1) when Pi≥1.0, the conclusion is that “the sample has the same or better detergency to the i^{th} kind of the stain cloth than the standard laundry detergent”, which is abbreviated as “the detergency to the i^{th} kind of stain cloth is qualified”;
(2) when Pi<1.0, the conclusion is that “the sample has inferior detergency to the ith kind of the stain cloth than the standard laundry detergent”, which is abbreviated as “the detergency to the ith kind of stain cloth is unqualified”.

The results are shown in Table 3 below.

TABLE 3

| | JB-01 stain | JB-02 stain | JB-03 stain | |
|---|---|---|---|---|
| | cloth | cloth | cloth | Results |
| Example 4 | 1.17 | 1.10 | 1.47 | Qualified |
| Example 5 | 1.12 | 1.07 | 1.38 | Qualified |
| Example 6 | 1.09 | 1.03 | 1.29 | Qualified |
| Example 7 | 1.21 | 1.14 | 1.41 | Qualified |
| Example 8 | 1.13 | 1.02 | 1.28 | Qualified |
| Example 9 | 1.15 | 1.07 | 1.31 | Qualified |
| Comparative | 0.95 | 0.88 | 1.12 | Unqualified |
| Example 4 | | | | |
| Comparative | 1.18 | 0.95 | 1.23 | Unqualified |
| Example 5 | | | | |
| Comparative | 1.18 | 1.07 | 1.38 | Qualified |
| Example 6 | | | | |
| Comparative | 1.15 | 1.37 | 1.22 | Qualified |
| Example 7 | | | | |
| Comparative | 1.12 | 1.29 | 1.19 | Qualified |
| Example 8 | | | | |

It can be seen from the data in Table 3 that, the detergent sheet of the present application has a good washing and deterging effect.

Fabric c conditioning anti-static test: the test was performed according to GB/T6801-2013. The tested concentration of the detergent sheets to be tested was 10.0 g/L. The test polyester cloth was commercially available from the China Research Institute of Daily Chemical Industry.

The surface specific resistance logarithm value difference being Δlg ρs≥2.5 is qualified. The results are shown in Table 4 below.

TABLE 4

| | Δlgρs | Results |
|---|---|---|
| Example 4 | 3.7 | Qualified |
| Example 5 | 3.8 | Qualified |
| Example 6 | 3.9 | Qualified |
| Example 7 | 4.3 | Qualified |
| Example 8 | 3.8 | Qualified |
| Example 9 | 3.7 | Qualified |
| Comparative Example 4 | 1.9 | Unqualified |
| Comparative Example 5 | 3.9 | Qualified |
| Comparative Example 6 | 3.8 | Qualified |
| Comparative Example 7 | 2.9 | Qualified |
| Comparative Example 8 | 3.1 | Qualified |

It can be seen from the data results in Table 4 that, the fabric washed with the detergent sheet of the present application has good anti-static performance, and it can be seen from Comparative Example 4, Comparative Example 7 and Comparative Example 8 that the detergent sheet of the present application has a better anti-static effect on fabric, which may be due to the fact that the release, dispersion, and solvent of the softener were not fully utilized after being coated and loaded on the carrier in Comparative Example 7 and Comparative Example 8.

The specific embodiment is only used for illustrating the present application but not for limiting the present application, and a person skilled in the art may make modifications without creative contribution to the present embodiment as required after reading the description, which fall within the protection scope of the present application.

What is claimed is:

1. A two-in-one solid detergent composition, comprising the following raw material components by weight: 10% to 30% of a forming agent, 10% to 50% of a surfactant, 5% to 20% of a softener, 10% to 30% of a forming aid, and deionized water;
wherein the surfactant comprises an anionic surfactant and a non-ionic surfactant; and
the anionic surfactant has a structure R¹(EO)ₙR²M, wherein n=1-15, R¹ is C₄-C₂₀ hydrocarbyl or C₄-C₂₀ substituted hydrocarbyl, R² is one or more selected from the group consisting of sulfate ions, sulfonate ions, phosphate ions and carboxylate ions, M is alkali metal ions or ammonium ions, and EO represents —CH₂CH₂O—.

2. The two-in-one solid detergent composition according to claim 1, wherein a weight proportion of the anionic surfactant to the non-ionic surfactant in the surfactant is from 1:9 to 9:1.

3. The two-in-one solid detergent composition according to claim 1, wherein the surfactant further comprises a zwitterionic surfactant, and a weight proportion of the zwitterionic surfactant in the surfactant is 10% to 40%.

4. The two-in-one solid detergent composition according to claim 1, wherein the forming agent is one or more selected from the group consisting of polyvinyl alcohol, polyvinyl alcohol crosslinked polymer, polyvinyl pyrrolidone and vinyl acetate-vinyl alcohol copolymer.

5. The two-in-one solid detergent composition according to claim 1, wherein the softener is one or more selected from the group consisting of an amino silicone oil, an amino silicone oil emulsion, an amino silicone oil microemulsion and a cationic polysiloxane and an emulsion thereof.

6. The two-in-one solid detergent composition according to claim 1, wherein the forming aid is one or more selected from the group consisting of anhydrous sodium sulphate, starch, kaolin, attapulgite, bentonite and silica.

7. The two-in-one solid detergent composition according to claim 1, further comprising the following raw material components by weight: 0.1% to 1% of a softening conditioner, 0.1% to 1% of a forming stabilizer, 1% to 10% of a water softener, 1% to 10% of a stain solubilizer or 0.1% to 5% of a flavoring agent, wherein a balance is the deionized water.

8. The two-in-one solid detergent composition according to claim 7, wherein the softening conditioner is cationic cellulose.

9. The two-in-one solid detergent composition according to claim 7, wherein the forming stabilizer is one or more selected from the group consisting of hydroxyethyl cellulose, hydroxypropylmethyl cellulose, gelatin, carrageenan and polyanionic cellulose.

10. The two-in-one solid detergent composition according to claim 7, wherein the stain solubilizer is polyols having a molecular weight of not more than 150.
